(19) United States
(12) Patent Application Publication
(10) Pub. No.: US 2002/0159532 A1
(43) Pub. Date: Oct. 31, 2002

(54) Computational circuits and methods for signal deconstruction/reconstruction in wireless transceivers

(75) Inventor: James Stuart Wight, Ottawa (CA)

Correspondence Address: William A. Webb, Brinks Hofer Gilson & Lione, P.O. Box 10395, Chicago, IL, 60610, US

(73) Assignee: IceFyre Semiconductor Corporation

(21) Appl. No.: 09/918,106

(22) Filed: Jul. 30, 2001

Related U.S. Application Data
(60) Provisional application No. 60/277,941, filed on Mar. 23, 2001.

(51) Int. Cl. H04K 1/10; H04L 27/28

(52) U.S. Cl. 375/260

(57) ABSTRACT

Circuits and methods are provided for use in an RF transmitter to complement the digital generation of a non-constant envelope modulation signals therein. A digital signal processor is configured for deconstructing a resultant signal having an undesirable property into one or more deconstruct signals which do not have the undesirable property. In a preferred embodiment the resultant signal is preconditioned by applying a preconditioning deconstruction process to an earlier signal from which said resultant is derived for deconstructing the earlier signal into one or more preconditioned deconstruct signals having an improved property over the earlier signal. For OFDM modulation scheme this undesirable property is a relatively high peak-to-average power ratio. Signals derived from the deconstruct signals are subject to conversion to analog signals and processing by power efficient, dynarnic-range limited analog circuits i.e. S Class power amplifiers and low compression-point up-converters, before being recombined for transmission.

### FIELD OF THE INVENTION

The invention relates to wireless transceivers producing digitally generated multi-carrier or single carrier QAM modulation signals (i.e. signals having non-constant envelopes) and, in particular, to computational circuits and methods for the transmitters thereof for deconstructing such modulation signals to obtain modulated signals having reduced peak-to-average power ratios.

### BACKGROUND OF THE INVENTION

In wireless (RF) transmitters data is typically scrambled, encoded, and interleaved before being modulated, up-converted and amplified and those functions occurring prior to modulation have typically been performed by computational means whereas the modulation and successive functions have in the past typically been analog. However, for nonconstant envelope modulation schemes such as multi-carrier modulation schemes (e.g. orthogonal frequency division multiplex (OFDM)) and single carrier quadrature amplitude modulation (QAM)), current realizations most often digitally generate these modulation signals (i.e. by computational means, typically a digital signal processor (DSP)) before the signal is fed to a digital-to-analog converter(DAC). Advantageously, computational modulation implementations enable more economical realizations of multi-carrier modulation and signal carrier QAM transceivers. As detailed herein, the inventor has discovered that such computational modulation environments provide a suitable framework in which to apply other pre-conditioning and/or complementary computations to the waveform before and/or after the modulation process is performed in order to achieve improved circuit performance. The terms “computational modulation” and “digitally generated modulation” are used interchangeably herein and for purposes herein the meaning of the former term is defined to be same as that of the latter term.

The up-converter and power amplifier of an RF transmitter must perform the frequency shifting and amplification of the modulated carrier with a minimum of distortion. For traditional single carrier modulation schemes, this implies a reasonably low dynamic range for the up-converter and also a reasonably small power back-off (from a 1 dB compression point) for the power amplifier. However, in order to achieve a minimum of distortion in a multi-carrier OFDM or single carrier QAM modulation scheme, the up/down converters must have a very high dynamic range (i.e. they must be linear and, hence, must have a high compression point), and a large power back-off (e.g. 12 dB) for the power amplifier is required, due to the high peak-to-average power ratios encountered. Both the high dynamic range requirement and the large power back-off requirement result in a very high DC power consumption for the transmitter and this creates a disadvantage of both OFDM and QAM for portable applications.

Known designs for the 802.11a 5 GHz wireless standard integrate the transmitter functions of scrambling, encoding, IFFT (Inverse Fast Fourier Transform) generation, modulating, up-converting, and power amplifying without directly addressing the problem of the high peak-to-average power ratio associated with OFDM modulation. There is a need, therefore, for 802,11a chip architectures that integrate the MAC, PHY and RF functions of the 802.11a, 5 GHz OFDM wireless standard and minimize the high dynamic range and large power back-off requirements. More specifically, there is a demand for circuitry as would enable the use of power efficient, dynamic-range limited RF circuits such as Class S power amplifiers (also referred to as Class D or Switch Mode power amplifiers) and low compression-point up-converters.

OFDM and other related multi-carrier modulation schemes are based on repetitively assigning a multiple of symbols to a multiple of carrier frequencies and calculating the IFFT to obtain the sequential segments of the time waveform to be transmitted. A significant problem for OFDM modulation is the very high peak-to-average power ratio that may occur during the time sequence output for each IFFT operation. A peak will occur when a majority of the individual carrier frequencies line up in-phase (if a peak appears, it is unlikely that a second one will occur within the same IFFT time segment due to the relatively small number of time samples). In order to establish phase references forth demodulation decision, training tones are periodically spaced throughout the multiple of carrier frequencies.

For OFDM modulators the first few samples of the time sequence output for each IFFT operation make up a guard interval. The guard interval occurs during the time in which the multi-path channel is stabilizing. In order to have available the complete IFFT time sequence for the receiver to operate on, the first few samples are cyclically rotated and appended to the end of the IFFT (making use of the shifting property of the Fourier transform pair). The time samples following the preamble are windowed with a weighting function in order to control frequency side-lobes. A typical weighting function is a trapezoidal waveform, having 1 time sample at both the beginning and end weighted to 0.5.

According to a known property of the Fourier transform pair, referred to as the shifting property, a shift in one domain corresponds to a complex rotation (phase shift) in the other domain. Further, for the FFT/IFFT realization, a progressive phase shift with respect to frequency in the frequency domain corresponds to a cyclic rotation of the corresponding time waveform segment.

### SUMMARY OF THE INVENTION

The inventor has discovered that the performance of circuits used for digitally generating modulation signals is improved by utilizing the computational environment thereof, before and/or after the modulation of signals, to deconstruct signals having an undesirable property into one or more resulting signals which do not have such undesirable property. In particular, the inventor has developed improvements for the design of circuitry for computational non-constant envelope modulation schemes, whereby a modulation waveform is deconstructed into components which, individually, have low peak-to-average power ratios. Preferably, these deconstruction processes are performed by applying pre-conditioning and/or complementary computations to the waveform before and/or after the modulation process. Advantageously, these deconstruction processes produce waveforms having reduced peak to average power ratios and the circuits realizing these processes enjoy substantially reduced power consumption for up-conversion and power amplification. Surprisingly, in marked contrast to known computational RF circuits, the modulated signals produced by the inventor's deconstruction processes are in form for further processing on the analog side of the transmitter by Class S power amplifiers and low compression-point up-converters

In accordance with the invention there is provided a signal deconstruction circuit for use in an RF transmitter and configured for complementing modulation circuitry of the transmitter which digitally generates a non-constant envelope modulation signal. A digital signal processor is configured for deconstructing a resultant signal having an undesirable property into one or more deconstruct signals which do not have that undesirable property, whereby signals derived from the deconstruct signals are subject to conversion to analog signals and processing by power efficient, dynamic-range limited analog circuits prior to being recombined for transmission. The undesirable property may be a relatively high peak-to-average power ratio, such as for OFDM circuits. The modulation circuitry comprises an Inverse Fourier transform processor and the deconstruction circuit may be operative before or after the Inverse Fourier transform processor.

Several exemplary computational engines for signal processing in accordance with the invention are disclosed herein. These exemplary engines complement each other and enable circuit architectures to be implemented which benefit from a reduced circuit complexity and repetitive use, and provide improved power consumption performance. Advantageously, by deconstructing the modulation signal into components having low peak-to-average power ratios, multiple identical up-converter/power amplifier circuits having low dynamic ranges and small power back-offs may be used (i.e. instead of a single high dynamic range up-converter and large power back-off amplifier). After the resulting deconstructed signals have been processed by the analog circuits (up-converter and power amplifier) they are recombined to form the multi-carrier modulation waveform. This minimizes the complexity and performance requirements of the analog circuits, reduces DC power consumption and reduces the required number of external components.

In accordance with one aspect of the invention the deconstruction circuit may comprise a carrier-sorting engine which sorts carriers of the resultant signal into a plurality of groups, each group forming one deconstruct signal, whereby the modulation circuitry comprises a plurality of Inverse Fourier transform processors for transforming the deconstruct signals, each Inverse Fourier transform processor being smaller than would be required to transform the resultant signal without the deconstruction of the same into the deconstruct signals. In a preferred embodiment, the carriers may be simultaneously sorted in more than one way to produce a plurality of alternative deconstruct signals for each group, whereby the group of deconstruct signals is selected on the basis of the group of deconstruct signals having the best peak-to-average power ratio.

In accordance with another aspect of the invention the deconstruction circuit may comprise a phasor fragmentation engine which deconstructs the resultant signal into a plurality of equal, varying amplitude deconstruct signals the phasors of which combine to form a phasor corresponding to the resultant signal, the amplitude of the deconstruct signals being a predetermined proportion of the variation of the amplitude of the resultant signal about the mean amplitude thereof. To do so the phasor fragmentation engine converts sequences of complex time samples output from the Inverse Fourier transform processor into two parallel sequences of equal, varying magnitude phasors at two phases whereby the phases are calculated to be θ−φ and θ+φ, whereby φ=cos⁻¹(0.5V/V_{PHASOR}) wherein V is the amplitude of the current sample of the resultant signal and V_{PHASOR} is the amplitude of said deconstruct signals calculated to be K₁V−K₂ wherein K₁ and K₂ are constants.

In one embodiment the phasor fragmentation engine deconstructs the resultant signal into a plurality of equal and constant amplitude deconstruct signals. Preferably, where the resultant signal is deconstructed into two deconstruct signals, the resultant signal is preconditioned by a second deconstruction circuit operative prior to the Inverse Fourier transform processor. Such second deconstruction circuit may comprise a carrier sorting engine. Alternatively, the second deconstruction circuit may comprise a preconditioning phasor fragmentation engine for preconditioning a second resultant signal prior to the processing of the resultant signal. In such embodiment the preconditioning phasor fragmentation engine deconstructs the second resultant signal into a plurality of equal, varying amplitude preconditioned deconstruct signals the phasors of which combine to form a phasor corresponding to the second resultant signal. The amplitude of the preconditioned deconstruct signals is a predetermined proportion of the variation of the amplitude of the second resultant signal about the mean amplitude thereof.

In an embodiment of the phasor fragmentation engine which deconstructs the resultant signal into two deconstruct signals the sequences of complex time samples output from the Inverse Fourier transform processor are converted into two parallel sequences of two equal magnitude phasors, equal to Vmax/2, at two phases. The phases of the two equal magnitude phasors are calculated to be θ−φ and θ+φ, respectively, whereby φ=cos⁻¹ (V/Vmax), with V being the amplitude of the current sample of the resultant signal and Vmax being the maximum amplitude of the resultant signal over the period of the sequence.

In an embodiment of the phasor fragmentation engine which deconstructs the resultant signal into three deconstruct signals the sequences of complex time samples output from the Inverse Fourier transform processor are converted into three parallel sequences of three equal magnitude phasors, equal to Vmax/3, at three phases. The phases of two of the equal magnitude phasors are calculated to be θ−φ and θ+φ, respectively, whereby φ=cos⁻¹[(1.5V/V_{MAX})−0.5], with V being the amplitude of the current sample of the resultant signal and Vmax being the maximum amplitude of the resultant signal over the period of said sequence. The third phase is equal to the phase of the resultant signal.

In accordance with another aspect of the invention the deconstruction circuit may comprise a virtual range-hopping engine configured for shifting a peak signal output from the Inverse Fourier transform processor to time samples targeted for attenuation by a preselected windowing function. Preconditioning of a resultant signal may be performed by such virtual range-hopping engine. Alternatively, preconditioning of a resultant signal may be performed by a light windowing engine omitting such shifting of a peak but including attenuation by a preselected windowing function.

Preferably, an amplitude and phase comparison calibration circuit is provided for adjusting differences in channel gains and phases between the deconstruct signals when combined following parallel up-converter/power amplifier chains to regenerate a modulated waveform. The calibration circuit comprises an error signal generator for generating error signals configured for adjusting the regenerated waveform.

### BRIEF DESCRIPTION OF THE DRAWINGS

A number of exemplary embodiments of the invention will now be described in detail with reference to the following drawings:

FIGS. 1(a) and 1(b) are block diagrams of components of radio transmitters including signal deconstruction engines for preconditioning and complementing digitally generated modulation processing in accordance with the invention, wherein FIG. 1(a) illustrates the use of a virtual range hopping engine for preconditioning and FIG. 1(b) illustrates an alternative signal processing function used for such preconditioning, namely, a light windowing engine;

FIGS. 2(a) and (b) are vector diagrams illustrating the addition of individual phasors (carrier signals) to produce resultant peak (FIG. 2(a)) and average (FIG. 2(b)) power levels for the peak-to-average power ratio;

FIG. 3 is a block diagram illustrating the steps performed by a carrier-sorting signal processing engine as part of an overall OFDM modulator;

FIGS. 4(a), (b) and (c) are graphs illustrating the application of a light windowing function (b) to a symbol output from an IFFT (a) to attenuate a high peak within the symbol (c);

FIGS. 5(a) and (b) illustrate two vector diagrams of a desired phasor V (being a resultant modulation signal), each at a different time ((a) and (b)), showing representations of the desired phasor V as the sum of two equal magnitude deconstruct phasors (K1 V-K2) which are continuously rotated to track the time varying magnitude and phase of the desired phasor whereby the magnitude of the two deconstruct phasors is dependent on the value of V (and, thus, is continuously adjusted);

FIG. 6 is a flow chart illustrating the computational steps performed by a digital signal processor to produce the two deconstruct phasors shown in FIG. 5;

FIGS. 7(a) and (b) illustrate two vector diagrams of a desired phasor V (being a resultant modulation signal), each at a different time ((a) and (b)), showing representations of the desired phasor V as the sum of two equal magnitude deconstruct phasors (Vmax/2) which are continuously rotated to track the time varying magnitude and phase of the desired phasor whereby the magnitude of the two deconstruct phasors is dependent on the maximum magnitude of V over the period of the sample (and is, thus, constant);

FIGS. 8(a) and (b) illustrate two vector diagrams of a desired phasor V (being a resultant modulation signal), each at a different time ((a) and (b)), showing representations of the desired phasor V as the sum of three equal magnitude deconstruct phasors (Vmax/3) which are continuously rotated to track the time varying magnitude and phase of the desired phasor whereby the magnitude of the three deconstruct phasors is dependent on the maximum magnitude of V over the period of the sample (and is, thus, constant);

FIG. 9 is a block circuit diagram of an amplitude and phase comparison calibration circuit;

FIGS. 10(a), (b) and (c) are graphs illustrating the processing performed by a virtual range-hopping signal processing engine, FIG. 10(a) showing a time sequence output for an IFFT operation and a peak occurring therein, FIG. 10(b) showing a trapezoidal symbol windowing function which includes a light windowing function in the guard interval and FIG. 10(c) showing a shifting of the time sequence output to a point at which the peak lines up with the declining slope of the sample window so as to attenuate the peak (and the repeated peak within the guard interval is also attenuated by the light windowing function); and,

FIG. 11 is a block diagram illustrating the steps performed by a virtual range-hopping signal processing engine as part of an overall OFDM modulator.

### DETAILED DESCRIPTION OF ILLUSTRATED EMBODIMENTS

In accordance with the invention claimed herein preconditioning and/or complementary computational signal processing engines are added to the standard computational processing performed by DSP (digital signal processor) modulators in the transmitter circuitry of an RF transmitter/receiver (transceiver). These processing engines deconstruct the modulation waveform into components that individually have low peak-to-average power ratios for which multiple identical up-converter/power amplifier circuits, having low dynamic ranges and small power back-offs, may be used. Surprisingly, the inventor has found that Class S power amplifiers and low compression-point up-converters may be used and this represents a marked and substantial improvement over known computational RF circuits for non-constant envelope modulation schemes. Following analog circuit processing the deconstructed signal components are recombined to form the desired multi-carrier OFDM modulation waveform (it is to be understood that in these examples an OFDM modulator is used but the invention is not limited to multi-carrier modulators and may be applied also to other non-constant envelope modulation schemes including single carrier QAM computational modulators),

The references herein to “deconstructing” a resultant signal mean that a signal (which may be characterized as a relatively “ill-behaved” waveform) is processed to transform it into a corresponding signal and/or subdivide it into deconstruct (i.e. subcomponent) signals which may be characterized as “better-behaved” signal(s), from the standpoint of the end-to-end limitations of RF transmitter circuitry. For convenience, the signal on which the deconstruction engines described herein operate on is alternatively referred to hereinafter as a “resultant” or “desired” signal.

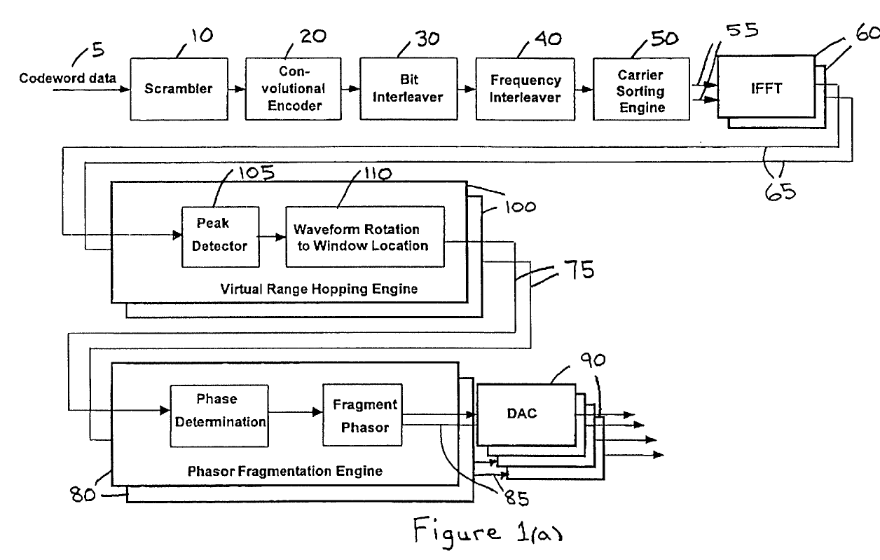

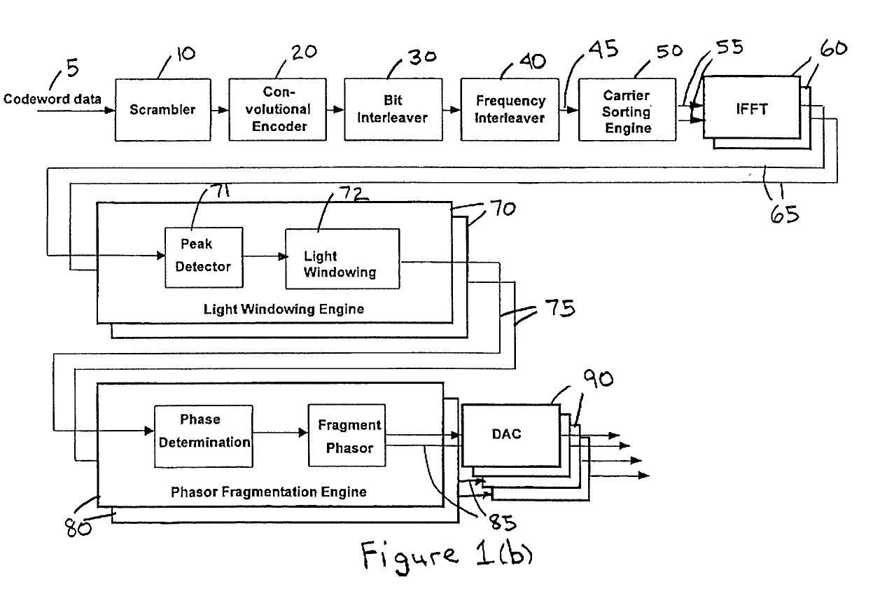

FIGS. 1(a) and (b) are block diagrams of transmitter configurations including signal deconstruction engines in accordance with the invention for preconditioning and complementing digitally generated modulation processing. In each of these illustrated embodiments a carrier sorting engine 50 according to one aspect of the invention preconditions the pre-modulation signal 45 following processing of the input signal 5 by a scrambler 10, an encoder 20 and bit and frequency interleaver processing blocks 30, 40. The carrier sorting engine 50 deconstructs the signal 45 into two subcomponent signals 55, each having lower peak-to-average ratios and which are input to IFFT's 60. Advantageously, each subcomponent signal 55 does not require as large an IFFT 60 as would be required by the pre-modulation signal 45 without this preconditioning so each IFFT 60 can be relatively small. Following the preconditioning by the carrier sorting engine 50 and transformation by the IFFT's the modulation signals 65 are, in these embodiments, again preconditioned by a virtual range hopping engine 100, in the case of the embodiment of FIG. 1(a), or a light windowing engine 70, in the case of the embodiment of FIG. 1(b), to remove peaks therefrom (whereby the light windowing engine 70 may be preferred for use where a lesser attenuation amount is satisfactory). The signals 75 output from the virtual range hopping or light windowing engines are deconstructed by phasor fragmentation engines 80 and the subcomponent signals 85 output therefrom are input to digital-to-analog converters 90.

Each of the signal deconstruction processing engines 50, 80 realizes a multiplicity of output signals from an original input signal, and the output signals produced by each engine 50, 70, 80 and 100 has a better peak-to-average power ratio than the signals input thereto. For the carrier sorting engine 50 the deconstructing operations take place in the frequency domain (preceding the IFFT operation) and for the, virtual range hopping, light windowing and phasor fragmentation engines the deconstructing operations take place in the time domain (following the IFFT operation). The signals output from these deconstruct engines need not be orthogonal. However, the deconstruction operations must be linear in nature, to enable reconstruction of the output signals 85 to a single signal, following up-conversion and power amplification.

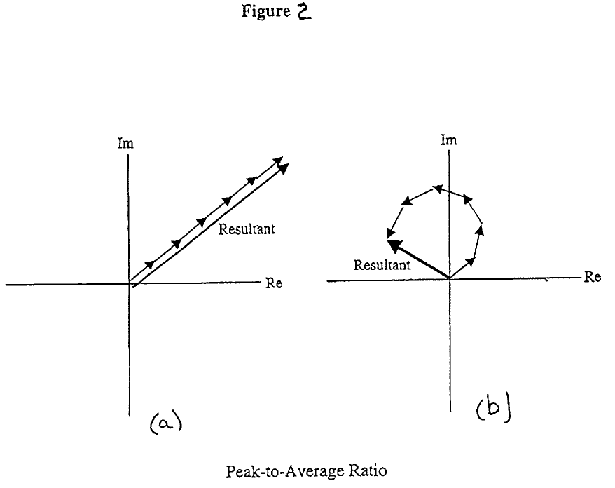

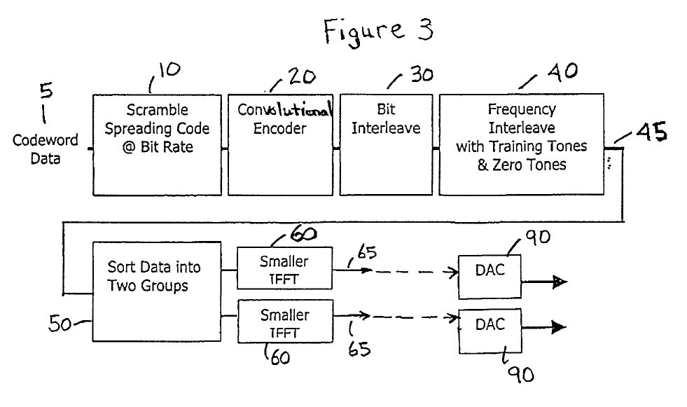

A carrier-sorting signal processing engine according to one aspect of the invention is illustrated by FIGS. 2 and 3. In the frequency domain, this engine sorts the carriers of the multi-carrier OFDM modulation signal 45 into two or more groups (two groups being used for the illustrated embodiment), each of which possesses an improved peak-to-average power ratio. For modulation schemes such as OFDM, the peak-to-average power ratio produced is a result of the individual phasors adding “in-phase” during the time of a peak (see FIG. 2(a)), but adding “randomly” at other times (see FIG. 2(b)). At times other than the peak, the summation of the powers of the individual phasors (carriers) to form the total power of the signal, corresponds to the summation of the square roots of the individual phasor magnitudes.

The difference between the summation of the phasor magnitudes (at the time of the peak) and the summation of the square root of the phasor magnitudes (at all other times) increases with the number of elements in the OFDM transform. For a given size of transform this difference is reduced by sorting the complex elements being applied to the transform (modulation for the individual carriers) into two (or more) groups. These groups are then applied to two (or more) smaller transforms (IFFT's), each having an appropriate scaling factor to account for the “missing” elements.

Referring to FIG. 3, the sequence of complex elements at the input to an IFFT engine is sorted into even and odd sequence-number groups (even and odd sequence-numbered carriers) and applied to two smaller IFFT engines. The resulting peak-to-average power ratio for each IFFT output is 3 dB smaller than that of the single, larger IFFT engine which would be required in the absence of such carrier-sorting processing. When the carrier sorting engine 50 is used as a preconditioning engine according to the embodiment illustrated by FIG. 1, the two IFFT outputs 65 are applied to a complementary phasor fragmentation engine 80 (and, as illustrated, a light windowing engine 70 may, optionally, also precondition the outputs 65 before they input to the phasor fragmentation engine 80). Alternatively, for a different embodiment it may be desired to use only the carrier sorting engine in which case the outputs 65 could be fed directly to digital-to-analog converters 90 (per the dotted lining in FIG. 3) and following the digital-to-analog converters 90 to parallel up-converters and power amplifiers (having 3 dB less dynamic range and back-off requirements) before being combined just prior to the air interface.

Optionally, it may be preferred to include an improvement over the foregoing single sorting algorithm of the carrier sorting engine 50, whereby the carriers (for any given number of groups) are sorted in more than one way, simultaneously, and the resulting assortments of signals are assessed and then the group which has the best peak-to-average power ratio is selected as an output signal 55.

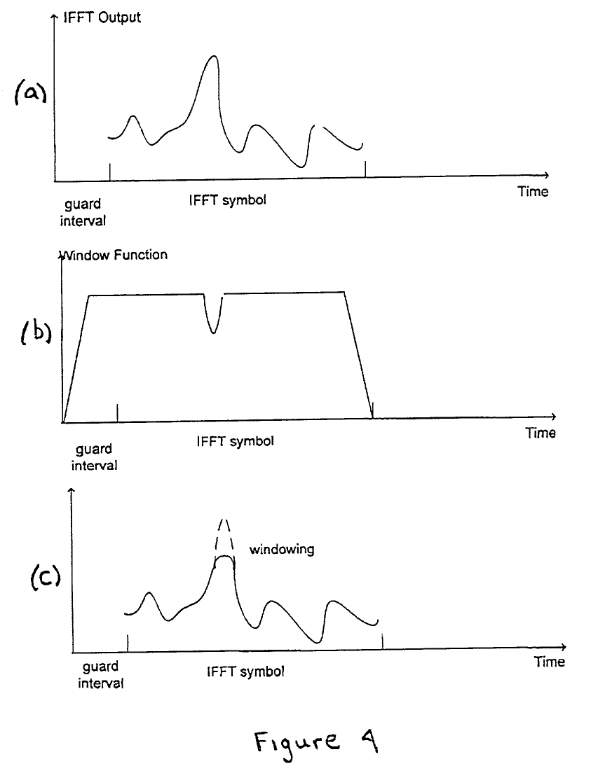

FIGS. 4(a), (b) and (c) are graphs illustrating the processing performed by the optional preconditioning light windowing engine 70 which is shown in FIG. 1(b). This engine includes a peak detector component 71 and a light windowing component 72. FIG. 4(a) illustrates a time sequence output from an IFFT 60 and FIG. 4(b) illustrates a light window function calculated by the engine 70 on the basis of a peak value of the time sequence as determined by the peak detector component 71. FIG. 4(c) shows the resulting time sequence after the light window function has been applied to it whereby the high peak shown in FIG. 4 (a) is attenuated.

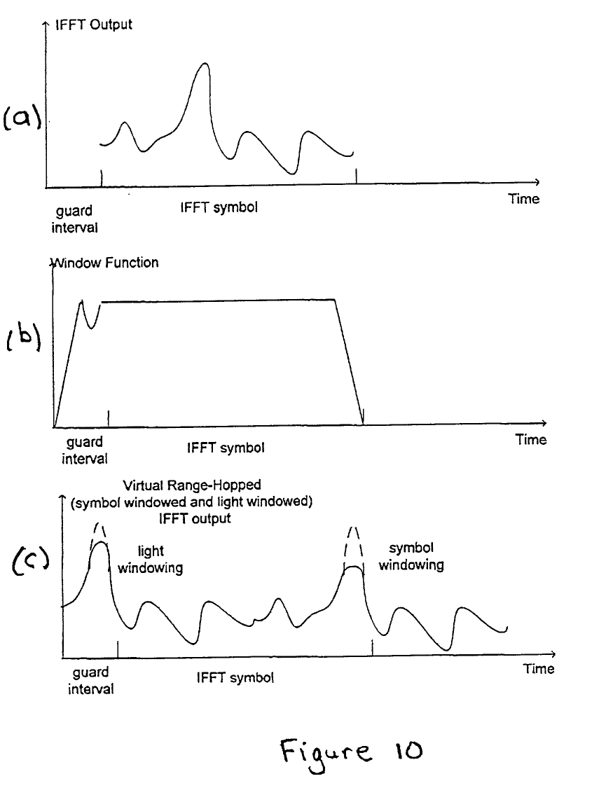

The optional virtual range hopping engine 100, which is shown in the embodiment of FIG. 1(a) for use as a preconditioning engine, is described in detail below with reference to FIGS. 10(a), (b) and (c) and 11.

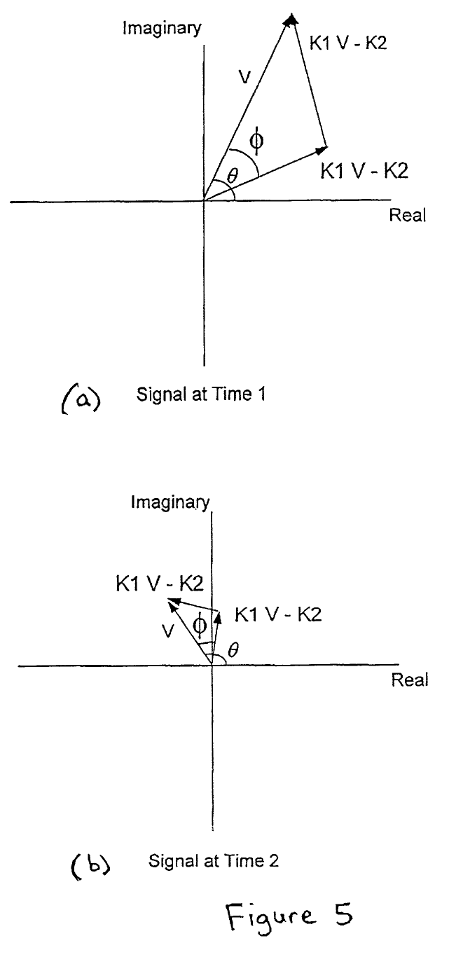

Deconstruction signal processors in accordance with further aspects of the invention are illustrated by FIGS. 5, 6, 7 and 8. These processors are referred to herein as phasor fragmentation engines and, because they are computational processes, their signal processing complements that of the digital modulation processing (being OFDM in the illustrated embodiment but this is equally true for QAM). As such, these engines enable the efficient use of power efficient, dynamic-range limited RF circuits, namely, Class S power amplifiers and low compression-point up-converters.

The phasor fragmentation engines make use of the property of the isosceles triangle and include phase determination and phasor fragment components. They convert a signal (viz. a desired phasor) having amplitude and phase variation, to two signals (viz. deconstruct phasors) each having a predetermined reduction in amplitude variation. In the limit, the amplitude variation is reduced to zero. The resulting reduced peak-to-average power ratio on each deconstruct phasor results in an increase in the rate of phase modulation experienced (because it is inherent to these engines that the greater the reduction in peak-to-average power ratio the greater will be the increase in phase modulation rate (bandwidth)).

A first embodiment of a phasor fragmentation engine is illustrated by FIGS. 5(a) and (b) and 6. FIGS. 5(a) and (b) illustrate two vector diagrams of a desired phasor V (i.e. a modulation signal), each at a different time ((a) and (b)), showing representations of the desired phasor V as the sum of two equal amplitude deconstruct phasors (K1 V-K2) which are continuously rotated to track the time varying amplitude and phase of the desired phasor. Each of the two phasors has its amplitude continuously adjusted to a predetermined proportion of the original signal's amplitude variation about its mean. As such, the individual phasor's peak-to-average ratios are reduced to the predetermined proportion.

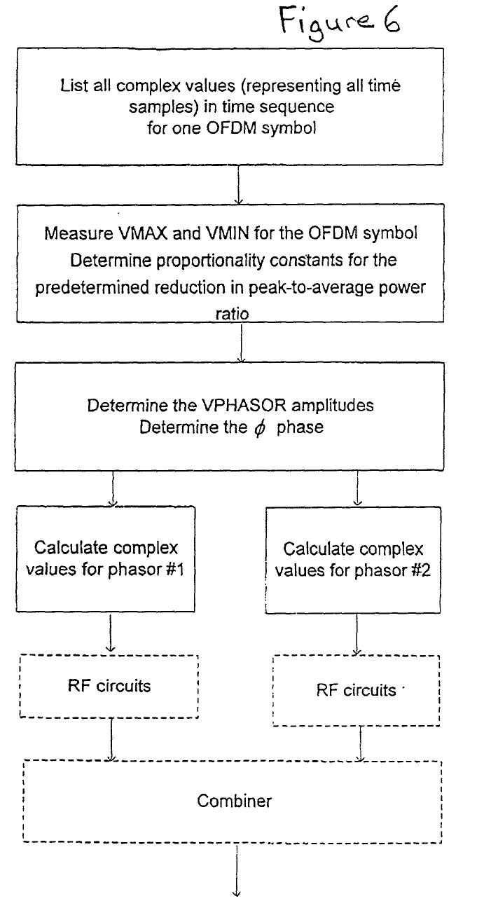

As shown in FIG. 5, the magnitude of the two deconstruct phasors is calculated as (K1 V-K2) and, because it is dependent on the value of V, the magnitude varies and is continuously adjusted as V changes. FIG. 6 illustrates the computational steps performed by a digital signal processor to produce the two deconstruct phasors shown in FIG. 5. The illustrated embodiment shows the use of two deconstruct phasors but an alternative embodiment may provide for more than two as appropriate.

For computationally generated OFDM or QAM signals, the signal is a sequence of complex (magnitude and phase) time samples. The phasor fragmentation engine converts this sequence to two parallel sequences for the two phasors (carriers). A preferred linear equation providing the predetermined proportion for the phasor amplitudes is the following:

$$\begin{matrix}{V}_{PHASOR} = a {V}_{MAX} ( V - {V}_{MIN} ) / ( {V}_{MAX} - {V}_{MIN} ) + \\ b {V}_{MIN} ( {V}_{MAX} - V ) / ( {V}_{MAX} - {V}_{MIN} ) \\ = {K}_{1} V - {K}_{2}\end{matrix}$$

wherein,

V_{PHASOR} is the amplitude (i.e. magnitude) of each of the two phasors

V_{MAX} is the maximum amplitude of the modulated signal

V is the current amplitude of the modulated signal

V_{MIN} is the minimum amplitude of the modulated signal

a and b are constants

By assigning a=0.5 and b=1.0 in the above equation a 6 dB reduction in the peak-to-average power ratio is achieved.

The phasor fragmentation engine illustrated by FIGS. 5 and 6 also adds and subtracts to the phase of the desired signal V at each time sample, to create the two phases for the phasors. The corresponding phase equation is:

φ=cos⁻¹(0.5 V/V_{PHASOR})

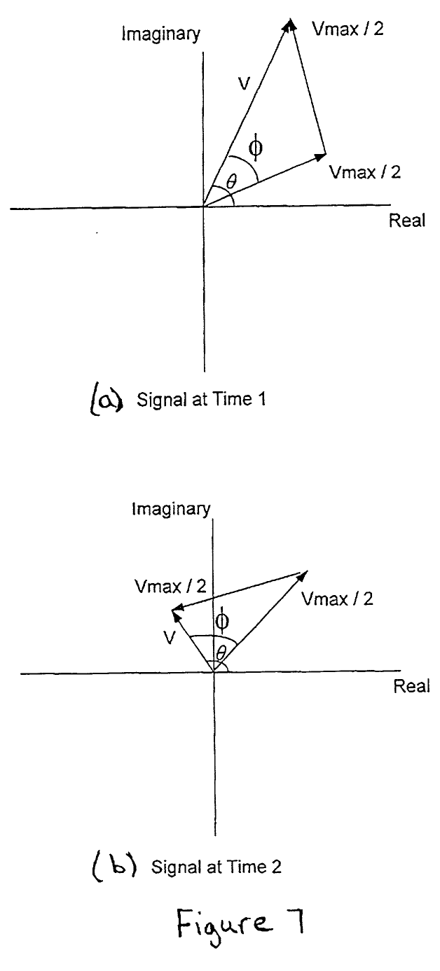

A second embodiment of a phasor fragmentation engine in accordance with another aspect of the invention is illustrated by FIGS. 7(a) and (b). As shown in these figures (wherein (a) represents one point in time and (b) represents another point in time) two equal, fixed magnitude phasors (Vmax/2) are continuously rotated in order to track the time varying magnitude and phase of the desired modulation signal V. The magnitude of the two deconstruct phasors is dependent on the maximum magnitude of V over the period of the sample and is, therefore, constant.

The amplitude for the two equal magnitude deconstruct phasors is:

V_{PHASOR}=V_{MAX}/2

To the phase at each time sample, this phasor fragmentation engine adds and subtracts φ whereby:

φ=cos⁻¹(V/V_{MAX})

In this embodiment, because the two deconstruct phasors are of constant magnitude, low dynamic range (low compression point) up-converters can be used. Further, highly efficient S Class power amplifiers can be used, providing no-backoff amplification.

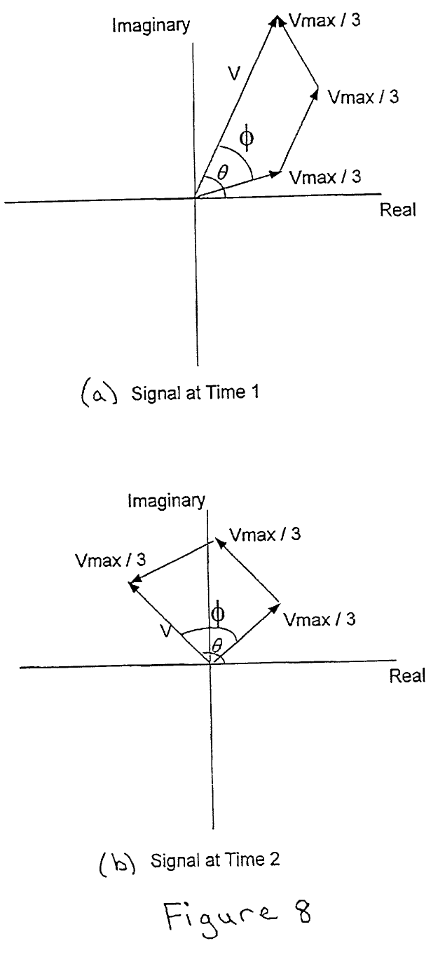

A third embodiment of a phasor fragmentation engine in accordance with another aspect of the invention is illustrated by FIGS. 8(a) and (b). As shown in these figures (wherein (a) represents one point in time and (b) represents another point in time), three equal, fixed magnitude phasors (Vmax/3) are continuously rotated in order to track the time varying magnitude and phase of the desired modulation signal V. The magnitude of the three deconstruct phasors is dependent on the maximum magnitude of V over the period of the sample and is, therefore, constant. This embodiment of a phasor fragmentation engine makes use of the property of isosceles triangles as well as that of coherent and incoherent signal addition.

The amplitude for the three equal magnitude phasors is:

V_{PHASOR}=V_{MAX}/3

To the phase at each time sample, the phasor fragmentation engine adds and subtracts φ to two of the three phasors, whereby:

φ=cos⁻¹[(1.5 V/V_{MAX})−0.5]

For the third deconstruct phasor, its phase is the phase θ of the phasor V at each time sample.

The phase φ is analytically dependent on the instantaneous amplitude of the desired phasor V (the resultant vector) and behaves pseudo-randomly. Since this phase is added to and subtracted from the phase of phasor V to form two of the deconstruct phasors, those two phasors effectively behave as being statistically independent. Further, since the remaining (third) deconstruct phasor is not affected by φ it will also behave as being statistically independent with respect to the other two deconstruct phasors.

When added together, these three statistically independent signals add on an individual power basis. However, on occasion the phases of the signals will align, and the signals will add on an individual amplitude basis. As a result, the three deconstruct signals when added together will result in a combined signal having a peak-to-average power ratio of 4.8 dB, without any inherent loss of power. Therefore, a signal having a peak-to-average ratio of up to 4.8 dB can be deconstructed into three phasors using this embodiment of the phasor fragmentation engine without sustaining any loss of power upon recombining.

In this embodiment, because the three deconstruct phasors are of constant magnitude, low dynamic range (low compression point) up-converters can be used. Further, highly efficient S Class power amplifiers can be used, providing no-backoff amplification.

Advantageously, the foregoing second and third embodiments of the phasor fragmentation engine are able to deconstruct a modulation signal having a peak-to-average power ratio of 3 dB or less, and 4.8 dB or less, respectively, and recombine the deconstruct phasors with 100% efficiency (i.e. no loss).

Further, it is to be noted that for very high peak-to-average power ratio signals, the efficiency of the foregoing second and third embodiment of the phasor fragmentation engine may suffer since the two or three phasors will frequently be near opposition (to generate the small average signal levels). However, when this second or third embodiment is used in conjunction with other peak-to-average power ratio reduction techniques such as the first foregoing embodiment of the phasor fragmentation engine, the foregoing carrier sorting engine and/or the virtual range-hopping engine described below (or for some embodiments the foregoing light windowing engine), the overall resulting efficiency will be high.

It is to be noted that for OFDM modulation each symbol period (resulting from an IFFT operation) will have a different peak value. It follows then that for the phasor fragmentation engine, each symbol period can be individually scaled. This dynamic scaling will enhance the overall bit-error rate performance of the OFDM link.

The carrier-sorting engine and the phasor-fragmentation engine reduce the peak-to-average power ratio of waveforms such as OFDM without compromising the air interface standard, by applying modified signals to parallel up-converter/power amplifier chains. Upon power combining, the OFDM waveform is regenerated. In order to ensure the OFDM waveform is not distorted, calibration circuits are required to compensate for differences in channel gains and phases.

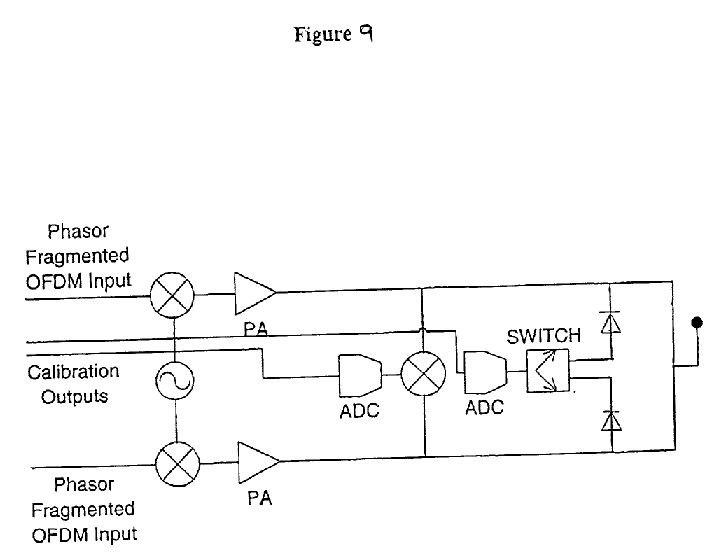

For use with the phasor fragmentation engines of the preferred embodiment an amplitude and phase comparison calibration circuit, such as that illustrated by FIG. 9, is included to provide error signals to an OFDM signal-processing engine in order to allow channel gains and channel phases to be adjusted for tracking. Gain tracking between two up-converter/power amplifier chains is achieved by measuring the difference in the power amplifier output signal levels, and using this difference to adjust the gain settings (scaling factors) in the signal processing engine, prior to the DACs.

For the foregoing second and third embodiments of the phasor fragmentation engine, gain tracking can be achieved on-line since the two or three parallel signals are of constant amplitude. For the carrier-sorting engine used without the phasor-fragmentation engine, gain tracking is achieved during a training interval on power-up, or as a result of a change in chip temperature, etc.

An effective way to continuously measure the difference in output signal levels is to couple some power from each output and sequentially direct these levels to a common diode detector, through a single-pole-double-throw (SPDT) switch. The detector output will have an AC component, the amplitude of which is proportional to the difference in output signal levels. This AC amplitude is passed to an ADC, and processed in the signal-processing engine to provide an adjustment in the gain (scaling factor).

Phase tracking between two up-converter/power amplifier chains can be achieved during a training interval on power-up, or as a result of a change in chip temperature, etc. Here the digital outputs from the digital processing engine are adjusted to form quadrature sinusoids, with the lead/lag phase relationship switching periodically. Following up-conversion and amplification by the power amplifier, some power from each output is coupled to a phase detector. The detector output will have an AC component, the amplitude of which is dependent on both the phase difference of the signals and the DC offset of the phase detector. This AC amplitude is passed to an ADC, and minimized by inserting a phase adjustment in the signal-processing engine. This minimum AC amplitude indicates the establishment of phase tracking through the up-converter/power amplifier chains.

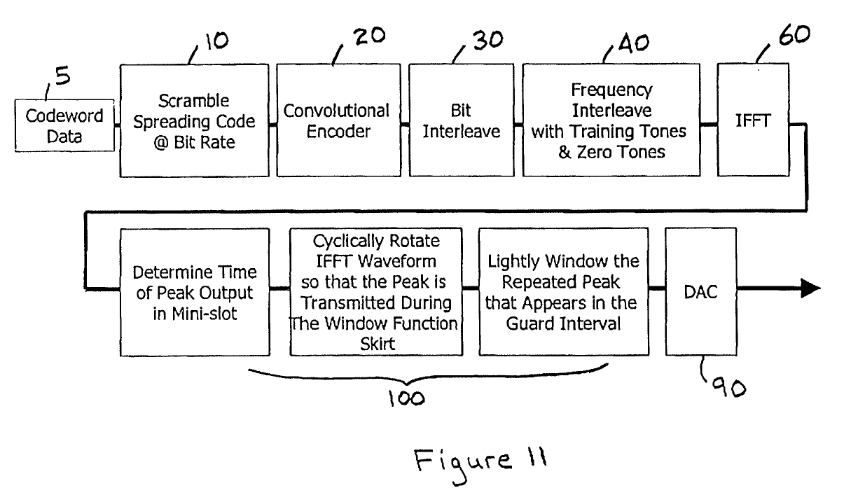

A further embodiment of the invention, referred to herein as the “virtual range hopping” signal deconstruction engine 100, is illustrated by FIGS. 10(a), (b) and (c) and 11. In addition, FIG. 1(a) illustrates a use of this engine as a preconditioning engine in combination with a carrier sorting engine, prior to a phasor fragmentation engine. FIG. 10(a) shows a time sequence output for an IFFT operation and a peak occurring therein. FIG. 10(b) shows a trapezoidal symbol windowing function which includes a light windowing function in the guard interval. FIG. 10(c) shows a shifting of the time sequence output to a point at which the peak lines up with the declining slope of the sample window so as to attenuate the peak (and the repeated peak within the guard interval is also attenuated by the light windowing function). FIG. 11 is a block diagram illustrating the steps performed by a virtual range-hopping signal processing engine as part of an overall OFDM modulator.

The virtual range hopping engine includes a peak detector component 105 for detecting a peak within a time sequence and a waveform rotation component 110 for shifting a detected peak to a pre-selected window location for attenuation. The time waveform segment generated by the IFFT operation is cyclically rotated (in accordance with the shifting property referenced above this occurs without loss of signal information) in order to place the peak signal value into the windowing function and thereby reduce the peak-to-average power ratio. As shown by FIGS. 10(a), (b) and (c), the shifting property is used to move the peak output during an IFFT operation to the time samples corresponding to the windowing function skirt. In this example, the peak is situated on the time sample having a weighting of 0.5 so its magnitude is decreased to one half and its power decreased by 6 dB. A peak moved to the trailing window function skirt will also appear in the leading guard interval and, as shown by FIG. 10(c) this peak can be attenuated using light windowing to a reduced level without disturbing the samples of the IFFT symbol period.

For other, more aggressive windowing functions the attenuation of the peak can be made even greater. As well, peaks that exist over more than one time sample can be handled with more aggressive windowing functions. The time shifting of the IFFT outputs will differ for each IFFT operation. The correct phase references for demodulation are obtained from the training tone phases. The result of this regular shifting of time is a virtual hopping in range for the transmitter Each time sequence resulting from an IFFT operation will have a different peak value. After this peak value is moved to the windowing function for attenuation, a new lower peak will dominate. Each time segment can be scaled so that their respective peaks achieve the same value. Such dynamic scaling enhances the overall bit-error rate performance of the OFDM link.

The individual electronic and processing functions utilised in the foregoing described embodiments are, individually, well understood by those skilled in the art. It is to be understood by the reader that a variety of other implementations may be devised by skilled persons for substitution. Persons skilled in the field of communication design will be readily able to apply the present invention to an appropriate implementation for a given application.

Consequently, it is to be understood that the particular embodiments shown and described herein by way of illustration are not intended to limit the scope of the invention claimed by the inventor which is defined by the appended claims.

What is claimed is:

1. A signal deconstruction circuit for use in an RF transmitter and configured for complementing modulation circuitry of said transmitter for digitally generating a non-constant envelope modulation signal, said deconstruction circuit comprising a digital signal processor configured for deconstructing a resultant signal having an undesirable property into one or more deconstruct signals which do not have said undesirable property, whereby signals derived from said deconstruct signals are subject to conversion to analog signals, processing by power efficient, dynamic-range limited analog circuits and recombination.

2. A circuit according to claim 1 wherein said undesirable property is a relatively high peak-to-average power ratio.

3. A circuit according to claim 2 wherein said modulation circuitry comprises an Inverse Fourier transform processor and said deconstruction circuit is operative on said resultant signal after said Inverse Fourier transform processor.

4. A signal deconstruction circuit for use in an RF transmitter and configured for complementing modulation circuitry of said transmitter for digitally generating a non-constant envelope modulation signal, said deconstruction circuit comprising a digital signal processor configured for deconstructing a resultant signal having an undesirable property into a plurality of deconstruct signals which do not have said undesirable property.

5. A circuit according to claim 4 wherein said undesirable property is a relatively high peak-to-average power ratio.

6. A circuit according to claim 5 wherein said modulation circuitry comprises an Inverse Fourier transform processor and said deconstruction circuit is operative on said resultant signal prior to said Inverse Fourier transform processor.

7. A circuit according to claim 5 wherein said modulation circuitry comprises an Inverse Fourier processor and said deconstruction circuit is operative on said resultant signal after said Inverse Fourier transform processor.

8. A circuit according to claim 6 comprising a carrier-sorting engine and said modulation is OFDM.

9. A circuit according to claim 8 wherein said carrier-sorting engine sorts carriers of said resultant signal into a plurality of groups, each said group forming one said deconstruct signal whereby said modulation circuitry comprises a plurality of Inverse Fourier transform processors for transforming said deconstruct signals, each said Inverse Fourier transform processor being smaller than would be required to transform said resultant signal without said deconstruction of the same into said deconstruct signals.

10. A circuit according to claim 9 wherein said carriers are simultaneously sorted in more than one way to produce a plurality of alternative deconstruct signals for each said group, whereby said deconstruct signals are selected from one said group on the basis of having the best peak-to-average power ratio.

11. A circuit according to claim 7 comprising a phasor fragmentation engine.

12. A circuit according to claim 11 wherein said phasor fragmentation engine deconstructs said resultant signal into a plurality of equal, varying amplitude deconstruct signals the phasors of which combine to form a phasor corresponding to said resultant signal, wherein said amplitude of said deconstruct signals is a predetermined proportion of the variation of the amplitude of said resultant signal about the mean amplitude thereof.

13. A circuit according to claim 12 wherein said phasor fragmentation engine deconstructs said resultant signal into two equal, varying amplitude deconstruct signals, said deconstructing comprising converting sequences of complex time samples output from said Inverse Fourier transform processor into two parallel sequences of equal magnitude phasor at two phases whereby said phases are calculated to be θ−φ and θ+φ, respectively, whereby φ=cos⁻¹(0.5V/V_{PHASOR}) wherein V is the amplitude of the current sample of said resultant signal and V_{PHASOR} is the amplitude of said deconstruct signals calculated to be K₁V-K₂ wherein K₁ and K₂ are constants.

14. A circuit according to claim 11 wherein said phasor fragmentation engine deconstructs said resultant signal into a plurality of equal and constant amplitude deconstruct signals.

15. A circuit according to claim 14 wherein said resultant signal is preconditioned by a second deconstruction circuit.

16. A circuit according to claim 15 wherein said second deconstruction circuit comprises a carrier sorting engine.

17. A circuit according to claim 15 wherein said second deconstruction circuit comprises a preconditioning phasor fragmentation engine for preconditioning a second resultant signal prior to said processing of said resultant signal, wherein said preconditioning phasor fragmentation engine deconstructs said second resultant signal into a plurality of equal but varying amplitude preconditioned deconstruct signals the phasors of which combine to form a phasor corresponding to said second resultant signal, wherein said amplitude of said preconditioned deconstruct signals is a predetermined proportion of the variation of the amplitude of said second resultant signal about the mean amplitude thereof.

18. A circuit according to claim 15 wherein said phasor fragmentation engine is configured for converting sequences of complex time samples output from said Inverse Fourier transform processor into two parallel sequences of two equal magnitude phasors, equal to Vmax/2, at two phases, whereby said phases of said two equal magnitude phasors are calculated to be θ−φ and θ+φ, respectively, whereby φ=cos⁻¹(V/Vmax) wherein V is the amplitude of the current sample of said resultant signal and Vmax is the maximum amplitude of said resultant signal over the period of said sequence.

19. A circuit according to claim 14 wherein said phasor fragmentation engine is configured for converting sequences of complex time samples output from said Inverse Fourier transform processor into three parallel sequences of three equal magnitude phasors, equal to Vmax/3, at three phases, whereby said phases of two said equal magnitude phasors are calculated to be θ−φ and θ+φ, respectively, and said third phase is equal to the phase of said resultant signal, whereby φ=cos⁻¹[(1.5 V_{MAX})−0.5], V being the amplitude of the current sample of said resultant signal and Vmax being the maximum amplitude of said resultant signal over the period of said sequence.

20. A circuit according to claim 3 comprising a virtual range-hopped engine configured for shifting a peak signal output from said Inverse Fourier transform processor to time samples targeted for attenuation by a preselected windowing function.

21. A circuit according to claim 15 wherein said second deconstruction circuit comprises a light windowing engine.

22. A circuit according to claim 15 further comprising an amplitude and phase comparison calibration circuit for adjusting differences in channel gains and phases between said deconstruct signals when combined following parallel up-converter/power amplifier chains to regenerate a modulated waveform, said calibration circuit comprising an error signal generator for generating error signals configured for adjusting said regenerated waveform.

23. A circuit according to claim 19 wherein said modulation is OFDM.

24. A circuit according to claim 23 further comprising an amplitude and phase comparison calibration circuit for adjusting differences in channel gains and phases between said deconstruct signals when combined following parallel up-converter/power amplifier chains to regenerate a modulated waveform, said calibration circuit comprising an error signal generator for generating error signals configured for adjusting said regenerated waveform.

25. A signal deconstruction method for complementing the generation of a digitally generated non-constant envelope modulation signal in an RF transmitter, said method comprising deconstructing a resultant signal having an undesirable property into a plurality of deconstruct signals which do not have said undesirable property whereby signals derived from said deconstruct signals are subject to conversion to analog signals, processing by power efficient, dynamic-range limited analog circuits and recombination.

26. A method according to claim 25 whereby said undesirable property is a relatively high peak-to-average power ratio.

27. A method according to claim 26 whereby said modulation signal is generated using an Inverse Fourier transform processor and said deconstructing is performed prior to modulation by said Inverse Fourier transform processor.

28. A method according to claim 26 whereby said modulation signal is generated using an Inverse Fourier transform processor and said deconstructing is performed subsequent to modulation by said Inverse Fourier transform processor.

29. A method according to claim 27 whereby said deconstructing comprises sorting carriers of said resultant signal into a plurality of groups, each said group forming one said deconstruct signal, whereby said modulation is performed by a plurality of Inverse Fourier transform processors for transforming said deconstruct signals, each said Inverse Fourier transform processor being smaller than would be required to transform said resultant signal without said deconstructing step.

30. A method according to claim 29 whereby said carriers are simultaneously sorted in more than one way to produce a plurality of alternative deconstruct signals for each said group and selecting said deconstruct signals for one said group on the basis of having the best peak-to-average power ratio.

31. A method according to claim 28 whereby said resultant signal is deconstructed into a plurality of equal, varying amplitude deconstruct signals the phasors of which combine to form a phasor corresponding to said resultant signal, wherein said amplitude of said deconstruct signals is a predetermined proportion of the variation of the amplitude of said resultant signal about the mean amplitude thereof.

32. A method according to claim 31 wherein said resultant signal is deconstructed into two equal, varying amplitude deconstruct signals and said deconstructing comprising converting sequences of complex time samples output from said Inverse Fourier transform processor into two parallel sequences of equal magnitude phasors, equal to Vmax/2, at two phases whereby said phases are calculated to be θ−φ and θ+φ, respectively, whereby θ=cos⁻¹(0.5V/V_{PHASOR}) wherein V is the amplitude of the current sample of said resultant signal and V_{PHASOR} is the amplitude of said deconstruct signals calculated to be K₁V−K₂ wherein K₁ and K₂ are constants.

33. A method according to claim 28 whereby said resultant signal is deconstructed into a plurality of equal and constant amplitude deconstruct signals.

34. A method according to claim 33 whereby said resultant signal is deconstructed into two said deconstruct signals and said resultant signal is preconditioned by deconstructing a second resultant signal into a plurality of equal but varying amplitude preconditioned deconstruct signals the phasors of which combine to form a phasor corresponding to said second resultant signal, wherein said amplitude of said preconditioned deconstruct signals is a predetermined proportion of the variation of the amplitude of said second resultant signal about the mean amplitude thereof.

35. A method according to claim 33 comprising converting sequences of complex time samples output from said Inverse Fourier transform processor into three parallel sequences of three equal magnitude phasors, equal to Vmax/3, at three phases, whereby said phases of two said equal magnitude phasors are calculated to be θ−φ and θ+φ, respectively, and said third phase is equal to the phase of said resultant signal, whereby φ=cos⁻¹[(1.5V/V_{MAX})−0.5], V being the amplitude of the current sample of said resultant signal and Vmax being the maximum amplitude of said resultant signal over the period of said sequence.

36. A method according to claim 28 comprising shifting a peak signal output from said Inverse Fourier transform processor to time samples targeted for attenuation by a preselected windowing function.
